(19) United States
(12) Patent Application Publication
(10) Pub. No.: US 2010/0129205 A1
(43) Pub. Date: May 27, 2010

(54) COMPRESSOR HOUSING AND TURBOCHARGER

(75) Inventor: Udo Schwerdel, Gerolsheim (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/595,325

(22) PCT Filed: Feb. 27, 2008
(86) PCT No.: PCT/EP08/52355

§ 371 Date: Oct. 9, 2009

(30) Foreign Application Priority Data
Apr. 16, 2007 (DE) 10 2007 017 825.7

(51) Int. Cl. F02B 37/16; F04D 27/00; F02B 37/18

(52) U.S. Cl. 415/148

(57) ABSTRACT

The present invention relates to a compressor housing (30) for a compressor (9) of a turbocharger (7) with an integral accommodation region (34, 36) for accommodating at least parts of an actuator (23, 29). The present invention further relates to a turbocharger (7) with a turbine (10) and a compressor (9), which turbocharger has such a compressor housing (30).

The present invention relates to a compressor housing for a compressor of a turbocharger. The present invention also relates to a turbocharger with a turbine and a compressor which has a compressor housing.

A turbocharger, or also exhaust gas turbocharger, is a supercharging system for an internal combustion engine, by means of which the cylinders of the internal combustion engine are subjected to an increased charge air pressure. The detailed structure and the mode of operation of such a turbocharger are known in multiple instances and are therefore only described briefly in the following. A turbocharger consists of an (exhaust gas) turbine in the exhaust gas stream (exhaust gas path), which is typically linked by way of a common shaft with a compressor in the intake tract (inflow path). The turbine is set into rotation by the exhaust gas stream from the engine and thus drives the compressor. The compressor increases the pressure in the intake tract of the engine, such that as a result of said compression a greater quantity of air enters the cylinders of the internal combustion engine during the intake cycle than in the case of a conventional naturally aspirated engine. This means that more oxygen is available for the combustion. As a result, the mean effective pressure of the engine and its torque increase, which significantly raises the power output. The delivery of a greater quantity of fresh air combined with the compression process is referred to as supercharging. The energy for the supercharging is taken from the fast-flowing, hot exhaust gases by the turbine. This energy, which would otherwise be lost through the exhaust gas system, is used in order to reduce the intake losses. The overall efficiency level of a turbocharged internal combustion engine is improved by this type of supercharging.

In order to adapt the turbine output power to different operating conditions of the internal combustion engine, a charging pressure control unit can be provided for the turbine. To this end, the turbine can be equipped with a variable turbine geometry, VTG. With regard to such a turbine, the blades of the turbine can for example be skewed such that the effective flow cross-sections of the blades, on which the exhaust gas stream acts, are changed. It is also possible to arrange a nozzle in the flow path of the exhaust gas stream, whereby the size of the through-opening of the nozzle can be varied. In order to adapt the turbine output power, it is likewise possible to provide a bypass valve (a so-called wastegate) for the turbine, by means of which the entire exhaust gas stream or a part of the exhaust gas stream can be directed past the blade wheel of the turbine. Actuators are used for operating the VTG and the bypass valve.

A turbocharger having a VTG is known from EP 1 426 580 B1 for example, wherein an actuator for operating the VTG is arranged in a bearing housing for seating the turbocharger shaft. The bearing housing is implemented between the turbine and the compressor of the turbocharger. The actuator is an electrical actuator which has a tubular linear electric motor. The VTG is operated by the actuator by means of a rod.

A VTG is known from DE 602 02 327 T2 which has a nozzle that is linked to an exhaust manifold of an engine. The nozzle contains a movable element which is driven by an actuator and can change the area of the nozzle constriction.

A turbocharger is known from U.S. Pat. No. 4,075,849 and DE 27 38 929 C3 which has a so-called wastegate. For operating the wastegate an actuator is provided which is arranged in a separate housing that is integrally linked with the turbine housing and is placed between the turbine housing and the compressor housing.

EP 1 250 523 B1 describes a turbocharger with a VTG, which is implemented by means of nozzles. The nozzles are operated by means of an actuator which is mounted externally on the compressor housing of a compressor of the turbocharger.

A supercharged engine is known from EP 1 236 875 B1 which has a turbocharger that may contain a VTG. In order to restrict the supercharging of the engine, instead of a wastegate electrically operated rotary slide valves are used which are arranged in induction manifolds. The induction manifolds link a mixture or air distributor with a bank of cylinders. The engine supercharging can be reduced by applying suitable control in order to close the rotary slide valves.

The object of the present invention is to render possible a low-cost compressor housing and accordingly a low-cost turbocharger in a technically simple manner.

This object is achieved by the technical teaching of claim 1 or claim 8. Advantageous embodiments of the invention can be taken from the dependent claims.

According to the invention, the compressor housing has an integral accommodation region for accommodating at least parts of an actuator. The turbocharger according to the invention contains a turbine and a compressor which has a compressor housing according to the invention. The actuator, or parts thereof, are advantageously arranged in the accommodation region of the compressor housing of the turbocharger according to the invention.

On the basis of the present invention, for the sake of convenience no separate housing is required for the actuator. In addition, there is no requirement to secure or mount such a separate actuator housing on another housing or another part of the turbocharger. Special parts, such as screws for example, for securing or installing a separate actuator housing are not needed. The turbocharger according to the invention can advantageously be installed in a simple manner and particularly cost-effectively. A compact and lightweight compressor housing and a compact and lightweight turbocharger can be ensured. In addition, a low model resource requirement, in other words pertaining in particular to a tool for manufacturing the housing, can be achieved. The present invention furthermore renders possible an especially short logistics supply chain for the manufacture of the compressor or of the turbocharger. On the basis of the present invention, the accommodation region is advantageously integrated mechanically into the compressor housing. The accommodation region is implemented in particular in a single piece with the compressor housing, or a particular part thereof. In addition, the accommodation region can advantageously be organized as a closed accommodation region which can if necessary be opened, by means of a cover for example. The actuator is advantageously an actuator for operating a control means for controlling a fluid stream in the turbocharger. The actuator can particularly advantageously be an electrical actuator, which in particular can be controlled by means of electrical control signals. This electrical actuator enables particularly precise and rapid control. The actuator can also be referred to as a final control element.

In an advantageous embodiment of the invention, the accommodation region is implemented in the interior of the compressor housing. As a result, a particularly compact arrangement is possible. In addition, parts of the actuator situated in the accommodation region can be particularly well protected against harmful external influences. The accommodation region implemented in the interior can be separated from the remainder of the interior of the compressor housing. As a result, parts of the actuator situated in the accommodation region are first and foremost separated from a rotatably mounted blade wheel arranged in the compressor housing. In particular, the accommodation region can be implemented in an edge area of the compressor housing. The accommodation region can advantageously be implemented to be closed or closable.

In a further particularly advantageous embodiment the accommodation region is implemented externally on the compressor housing. As a result, the forms of the accommodation region and the interior of the compressor housing can be configured largely independently of one another. In addition, the parts of the actuator situated in the accommodation region are for the sake of convenience particularly easily accessible, with regard to a maintenance or repair procedure for example, without the need to open the compressor housing.

By preference, the accommodation region is implemented on a cover of the compressor housing. This advantageously ensures a particularly good arrangement of the accommodation region.

By particular preference, the actuator is configured for operating a recirculation valve which serves to open and close a connecting line that is arranged between an outlet from the compressor allowing compressed air to exit and an inlet to the compressor allowing air to enter. The actuator, or parts thereof, can advantageously be arranged in a particularly space-saving manner in the accommodation region. The recirculation valve serves to control an air stream which is to be output from the compressor to an engine. The recirculation valve causes a feedback of compressed air from the outlet to the inlet. It is opened in particular in the situation when a throttle valve of the engine, by way of which the compressed air is introduced into the engine, is already closed and the compressor continues to deliver compressed air, primarily on account of the mass inertia of its blade wheel.

Furthermore, the actuator is preferably configured for operating a control means which serves to control an exhaust gas stream from a turbine of the turbocharger. This actuator, or parts thereof, can advantageously be arranged in a particularly space-saving manner in the accommodation region. The control means can in particular be a so-called variable turbine geometry, VTG, and/or a bypass valve for bypassing the turbine, in other words a so-called wastegate. The accommodation region is particularly advantageously configured such that both the actuator, or parts thereof, for operating the recirculation valve, and also the actuator, or parts thereof, for operating the control means which serves to control the exhaust gas stream from the turbine of the turbocharger, can be arranged in the accommodation region.

By particular preference, the compressor housing is manufactured from cast aluminum. A compressor housing implemented thus is particularly lightweight and stable. In addition, it can be produced cost-effectively and simply by casting.

The invention and its advantages will be described in detail in the following with reference to examples and exemplary embodiments and the attached drawing. In the drawings:

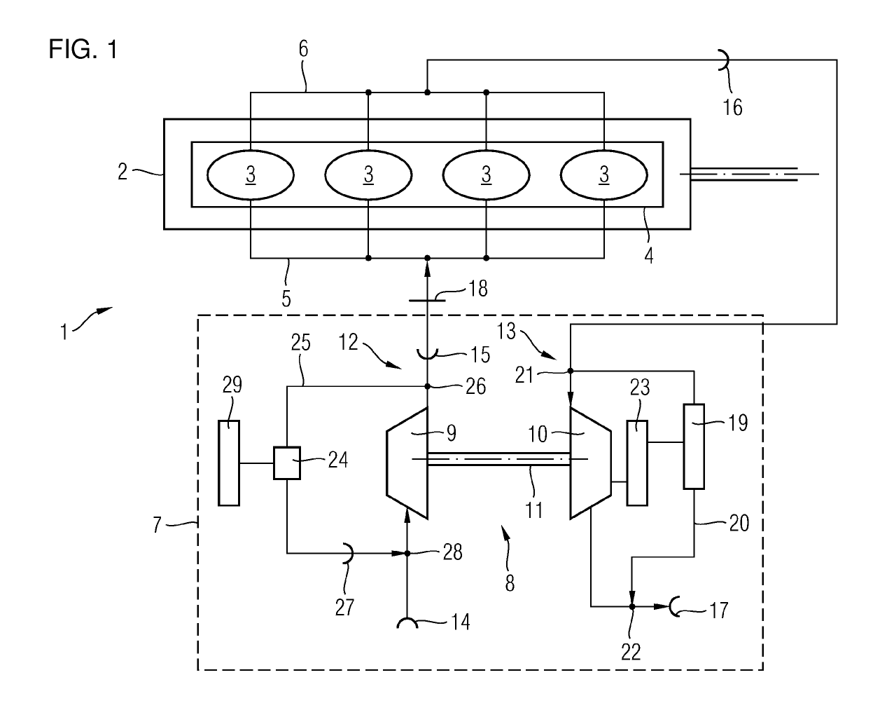

FIG. 1 shows a schematic representation of an example of an internal combustion engine of a motor vehicle with an exemplary embodiment of a turbocharger according to the invention, which has a compressor housing according to the invention,

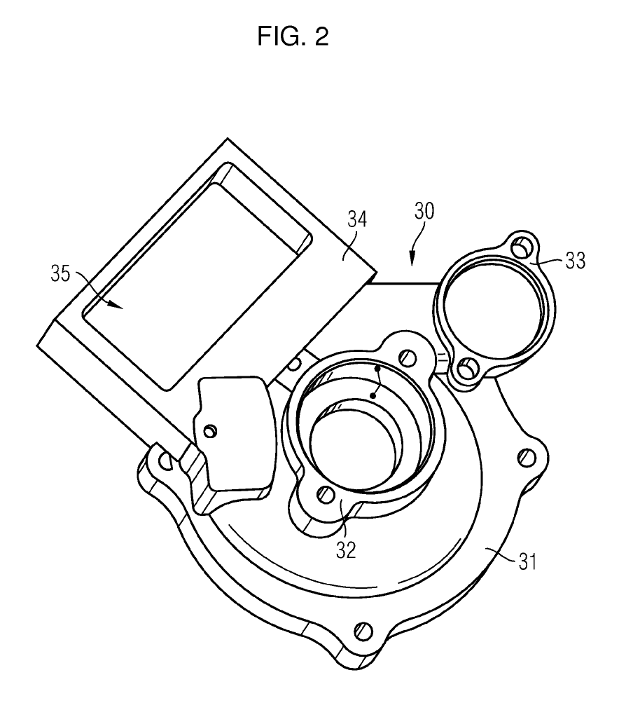

FIG. 2 shows a schematic representation of an exemplary embodiment of a compressor housing according to the invention, whereby an integral accommodation region for accommodating an actuator is present on a cover of the compressor housing according to the invention, and

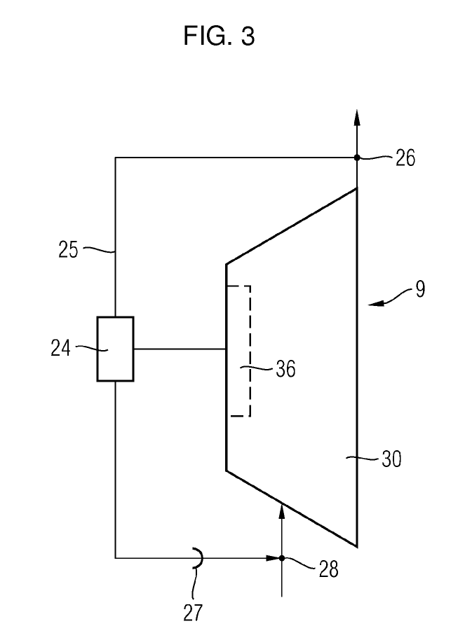

FIG. 3 shows a schematic representation of a further exemplary embodiment of a compressor housing according to the invention, whereby an integral accommodation region for accommodating an actuator is implemented inside the compressor housing.

In the figures, the same elements or elements having the same function—unless specified otherwise—are identified by the same reference characters in the following.

FIG. 1 shows a schematic representation of an internal combustion engine 1 which is used in a motor vehicle. The internal combustion engine 1 is a turbocharged internal combustion engine, for example a gasoline engine or a diesel engine. The internal combustion engine 1 has an engine block 2 which in the example illustrated contains four cylinders 3 and a cylinder head 4. In a known manner the internal combustion engine 1 furthermore has an intake manifold 5 as well as an exhaust manifold 6, which in FIG. 1 are simply indicated schematically and greatly simplified. The intake manifold 5 thus forms the (fresh) air inlet side of the engine block 2 and the exhaust manifold 6 forms its exhaust gas outlet side.

The internal combustion engine 1 has a turbocharger 7 which is represented greatly simplified in FIG. 1. The turbocharger 7 according to FIG. 1 is implemented in a single stage and has a turbocharger stage 8 which has a compressor 9 and a turbine 10. The compressor 9 and the turbine 10 are coupled to one another by means of a rotatable shaft 11. The compressor 9 is arranged in an inflow path 12 and the turbine 10 in an outflow path 13. The inflow path 12 of the turbocharger 7 is defined between a fresh air inlet 14, by way of which fresh air is taken in, and a fresh air outlet 15, by way of which fresh air compressed by the compressor 9 is made available by the turbocharger 7. The outflow path 13 of the turbocharger 7 is defined between an exhaust gas inlet 16, by way of which exhaust gas produced by the internal combustion engine 1 is introduced into the turbocharger 7, and an exhaust gas outlet 17, by way of which the exhaust gas can escape. In this respect the exhaust manifold 6 is connected to the exhaust gas inlet 16 for the turbocharger 7. The compressed fresh air delivered by the turbocharger 7 is fed to the fresh air inlet side of the internal combustion engine 1, in other words to the intake manifold 5. In this respect the intake manifold 5 is here connected to the fresh air outlet 15 of the turbocharger 7. Between the fresh air outlet 15 and the intake manifold 5 is a throttle valve 18, with which the feed of compressed fresh air can be controlled, in other words permitted or inhibited here, in a known manner. To this end the throttle valve 18 is capable of being opened and closed. The inflow path 12 is frequently also referred to as intake tract, fresh air side, compressor side or charge air side. The outflow path 13 is frequently also referred to as exhaust gas path or exhaust gas side.

In order to set and regulate the charging pressure of the turbine 10, a bypass valve 19, in other words a wastegate, is provided in a bypass line 20 in an already known manner. The bypass line 20 runs parallel to the turbine 10 and bypasses the latter starting from a branch point 21 at the inlet of the turbine 10 and extending to a joining point 22 at the outlet of the turbine 10. In this manner, exhaust gas coming from the engine block 2 by way of the exhaust gas inlet 16 can, when the bypass valve 19 is open, be routed past the turbine 10 by way of the bypass line 20. This exhaust gas routed past thus does not contribute to the generation of output power by the turbine 10. In order to set and regulate the charging pressure of the turbine 10, this can also be equipped in an already known manner with a variable turbine geometry, VTG. In order to operate the bypass valve 19, this is connected to an actuator 23 which here is advantageously an electrical actuator. The actuator 23 acts on the bypass valve 19 such that the latter can be opened and closed by the operation of the actuator 23. The actuator 23 is configured here such that it likewise connected to the mechanism of the VTG. As a result, the VTG can be operated by way of the actuator 23. It is however similarly possible to provide a separate actuator for operation of the VTG. The bypass valve 19 and the VTG of the turbine 10 here each constitute a control means for controlling a fluid stream in the turbocharger 7. In this case the fluid stream is in particular the exhaust gas stream which is used effectively by the turbine 10 to perform work in order to drive the shaft 11.

In order to control the compressed fresh air stream output by the compressor 9 at the fresh air outlet 15, a recirculation valve 24 is provided in a connecting line, which constitutes a feedback line 25 for feeding back already compressed fresh air. The feedback line 25 runs parallel to the compressor 9, starting from a branch point 26 at the outlet 15 of the compressor 9 and extends to an inlet 27 of the compressor 9 in order to admit fed-back compressed fresh air. The inlet 27 is connected to a joining point 28, at which compressed fresh air fed back by way of the feedback line 25 can be added to the fresh air admitted by way of the fresh air inlet 14. The recirculation valve 24 is opened in particular in the situation when the throttle valve 18 is already closed but the compressor 9 continues to compress and output fresh air primarily on account of the mass inertia of its blade wheel. This compressed fresh air, which is no longer fed to the engine block 2 on account of the closed throttle valve, can thus be fed into the compressor again by way of the feedback line 25. In order to operate the recirculation valve 24, this is connected to an actuator 29 which here is advantageously an electrical actuator. The actuator 29 acts on the recirculation valve 24 such that the latter can be opened and closed by the operation of the actuator 29. This then causes the feedback line 25 to open or close. The recirculation valve 24 here constitutes a control means for controlling a fluid stream in the turbocharger 7. In this case the fluid stream is in particular the compressed fresh air stream which is output by the compressor 9 to the throttle valve 18.

In the turbocharger 7 the compressor 9 has a separate compressor housing and the turbine 10 has a separate turbine housing. FIG. 2 shows a schematic representation of an exemplary embodiment of a compressor housing 30 according to the invention for the compressor 9. The illustration includes a cover 31 for the compressor housing 30. On the cover 31 are mounted a connection 32 for an intake filter for the fresh air drawn in by way of the fresh air inlet 14 and also a flange 33 as the connection for a line for the output of compressed fresh air to the engine block 2. In addition, an integral accommodation region 34 for accommodating parts of the actuators 23 and 29 or the complete actuators 23 and 29 is implemented on the cover 31. The accommodation region 34 is integrally linked with the cover 31. The cover 31 and the accommodation region 34 are designed as a single piece and implemented in the present exemplary embodiment, as is likewise the remainder of the compressor housing, as a cast aluminum component. The compressor housing can however equally be manufactured entirely or partially from plastics.

The accommodation region 34 is configured here in a pot shape, such that it has a depression 35. The accommodation region 34 can however equally have a different form. A cover can be fitted on the depression 35 in order to close the accommodation region 34. Parts of the actuators 23 and 29 can be arranged in the depression 35 in the accommodation region 34. It is also possible to accommodate the complete actuators 23 and 29 in the depression 35. In addition it is possible to provide separate accommodation regions for the actuators 23 and 29, or parts thereof. It is particularly advantageous to arrange the actuator 23, or parts thereof, on the compressor side so as not to subject it to the turbine-side heat of the exhaust gas. In order to operate the bypass valve 19, and if applicable the VTG, by means of the actuator 23 placed in the accommodation region 34, a slider or a control rod can be provided which projects from the accommodation region 34 and which can operate the bypass valve, and if applicable the VTG. Parts of the actuators 23 or 29, which can be arranged in the depression 35, can for example be one or more electric motors, different wheels, for a gear transmission in particular, electrical connections, a circuit board together with fastenings, etc.

In the present exemplary embodiment according to FIG. 2 the integral accommodation region 34 is implemented on the outside of the cover 31. It is however equally possible to implement the accommodation region 34 at a different position on the compressor housing 30. This can be on the outside of the compressor housing 30 or alternatively in the interior, on the inside in particular, of the compressor housing 30.

FIG. 3 shows a schematic representation of a further exemplary embodiment of a compressor housing 30 according to the invention. In this exemplary embodiment, an integral accommodation region 36 for accommodating at least one of the actuators 23 and 29, or parts thereof, is implemented inside the compressor housing 30. In this case the accommodation region 36 is implemented directly on the inside of the compressor housing 30. It is however equally possible to implement the accommodation region 36 extending further into the interior of the compressor housing 30. Likewise, it is not necessarily essential to implement a closed accommodation region 36 or one at least partially delimited by means of walls etc. It can also be sufficient to configure the form of the compressor housing 30 such that a certain, in particular open, space, in other words accommodation region 36, is present in the interior of the compressor housing 30, which allows at least one of the actuators 23 and 29, or parts thereof, to be accommodated or arranged therein. In this situation, the form of the compressor housing 30, and thus of the accommodation region 36, is configured such that the correct operation of the compressor 9, in particular the rotation of a blade wheel present in the interior of the compressor housing 30, is ensured and is not impaired by the arrangement of the actuators, or parts thereof.

1-8. (canceled)

9. A compressor housing for a compressor of a turbocharger, the compressor having an inlet and an outlet, the compressor housing comprising:
an integral accommodation region for accommodating at least parts of a first electrical actuator for operating a wastegate and of a second electrical actuator for operating a recirculation valve, said recirculation valve effecting a feedback of compressed air from the outlet of the compressor to the inlet.

10. The compressor housing according to claim 9, wherein said accommodation region is implemented in an interior of the compressor housing.

11. The compressor housing according to claim 9, wherein said accommodation region is implemented externally on the compressor housing.

12. The compressor housing according to claim 9, which further comprises a cover of the compressor housing, and wherein said accommodation region is implemented on said cover of the compressor housing.

13. The compressor housing according to claim 9, wherein the parts of said first and second actuators to be accommodated in said accommodation region or in a depression in said accommodation region, are devices selected from the group consisting of one or more electric motors, wheels, electrical connections, and a circuit board together with fasteners.

14. The compressor housing according to claim 13, wherein said accommodation region of the depression are configured to accommodate gear wheels for a gear transmission.

15. The compressor housing according to claim 9, wherein said second electrical actuator is configured for operating a recirculation valve that serves to open and close a connecting line between an outlet from the compressor allowing compressed air to exit and an inlet to the compressor allowing air to enter.

16. The compressor housing according to claim 9, wherein said first electrical actuator is configured for operating a control means for controlling an exhaust gas stream from a turbine of the turbocharger.

17. The compressor housing according to claim 9, formed of cast aluminum.

18. A turbocharger, comprising a turbine and a compressor having a compressor housing according to claim 9.

19. The turbocharger according to claim 18, wherein said compressor housing is formed of cast aluminum.
